(19) United States
(12) Patent Application Publication
(10) Pub. No.: US 2022/0120844 A1
(43) Pub. Date: Apr. 21, 2022

(54) METHOD FOR INTERFERENCE SUPPRESSION AND METHOD FOR SIGNAL RESTORATION

(71) Applicant: ZF FRIEDRICHSHAFEN AG, Friedrichshafen (DE)

(72) Inventors: JONATHAN BECHTER, Aulendorf (DE); FLORIAN ENGELS, Wangen im Allgäu (DE); MOUHAMMAD ALHUMAIDI, Friedrichshafen (DE); AMARILDA DEMIRLIKA, Friedrichshafen (DE)

(21) Appl. No.: 17/298,690

(22) PCT Filed: Dec. 6, 2019
(86) PCT No.: PCT/EP2019/084071

§ 371 Date: Dec. 15, 2021

(30) Foreign Application Priority Data
Dec. 10, 2018 (DE) 10 2018 221 285.6

(51) Int. Cl. G01S 7/02; G01S 7/35

(52) U.S. Cl. CPC G01S 7/023; G01S 7/356

(57) ABSTRACT

The invention relates to a method for interference suppression, wherein: a. a time signal (10) is provided, b. an interference range (16) of the time signal (10) is determined, c. a modified time signal (18) is provided by suppressing the interference range (16) of the time signal (18), d. a spectrum (20) of the modified time signal (18) is determined and a suppression spectrum (28) of the suppressed interference range (16) is determined, e. a real frequency component (30) of the spectrum (20) is determined, f. a modified suppression spectrum (34) is determined from a characteristic variable of the real frequency component (30) of the suppression spectrum (28), g. the modified suppression spectrum (34) is subtracted from the spectrum (20) to provide a corrected spectrum (36). The invention also relates to two methods for signal restoration on the basis of the method for interference suppression.

The invention relates to a method for interference suppression and to a method for signal restoration.

Such a method is described by “Marvasti et al: Sparse Signal Processing Using iterative Method with Adaptive Threshold (IMAT)”. The method initially involves a time signal being provided in which subregions of the time signal are unknown. The values within these subregions are zeroed in order to provide a modified time signal, which is then converted into a frequency spectrum by means of a Fourier transformation. The zeroed subregions mean that corresponding disturbance components arise within the frequency spectrum, which are also called side lobes. Such side lobes are distributed around real frequency components, but have a smaller amplitude than the real frequency component. Those frequency components within the spectrum that have the greatest amplitude can accordingly be said with certainty to be real frequency components. They are identified by means of a limit value. To restore the frequency components of the subregions of the time signal, the frequency components above the limit value are subjected to an inverse Fourier transformation. This produces a corrected time signal that fills the zeroed subregions. This already partially reconstructs the original time signal. The corrected time signal is subjected to the outlined steps once again, the corrected time signal being used to ascertain the frequency spectrum. This produces a further correction for the time signal by means of a new limit value and the corresponding frequency ranges. This makes use of the circumstance that the further processing of the corrected time signal means that the side lobes already have a smaller amplitude in the frequency spectrum and therefore a low limit value can be used. This iterative process is repeated several times until a spectrum or a time signal of the desired quality level has been obtained.

The IMAT method requires a large number of Fourier transformations, which are particularly memory and computation intensive. For this reason, this method can be implemented only with a high level of financial expenditure, in particular for mobile applications, that is to say for real-time evaluations of radar signals in mobile objects. This is the case in particular with automotive applications that provide driving assistance functions or autonomous driving functions. Here, FMCW (Frequency Modulated Continuous Wave) radars are often used, which require Fourier transformations for resolving detections in distance, velocity, azimuth angle and elevation angle.

It is therefore an object to provide a method for signal restoration and for interference suppression that is more computationally efficient.

This object is achieved by a method for interference suppression according to the features of claim 1 and a method for signal restoration according to claim 3 and also a method for signal restoration according to claim 4. Advantageous variant embodiments are outlined in the dependent claims.

The method is in particular suitable for application in areas in which computation capacity can be provided only at correspondingly high costs. In particular, the method is suitable for radar systems formed in mobile objects. These can be for example radar systems for motor vehicles or other autonomous vehicles. Such a radar system can be in the form of frequency modulated continuous wave radar, FMCW radar, for example.

The way in which FMCW radars work is sufficiently well known. In particular, this system transmits radar waves in the form of multiple successive chirps or frequency ramps, which are reflected by objects within the visual range, the reflected radar waves being detected by the reception antennas. The detected signals are then evaluated by way of multiple Fourier transformations. The Fourier transformations allow the information of the time signals to be resolved with respect to the distance, the velocity and an elevation angle and an azimuth angle for each detection. The method described below can be applied just for a single one or else to several of the aforementioned dimensions. Where examples are cited below, these relate just to the application in a single dimension for the sake of simplicity, in order to allow simpler understanding of the way in which the method works. The method is extended to another dimension or to further dimensions mutatis mutandis.

According to the method for interference suppression according to claim 1, a first step a involves a time signal being provided. Such a time signal can be for example a measurement signal from a RADAR system or else a time signal from another source. In particular, the time signal is provided as a digital signal. To this end, an analog measurement signal can be converted into a digital measurement signal by means of an analog-to-digital converter. A digital time signal has a plurality of sampling locations that arise from the sampling of an analog signal.

A further step b involves an interference region of the time signal being ascertained. The interference region has disturbances in the actual time signal. Such a disturbance can have various underlying causes. In the case of RADAR systems, this can arise for example due to RADAR signals transmitted by another RADAR system. The disturbance within the interference region means that the time signal in this region cannot be used for the further processing, since the disturbance components within the frequency spectrum mean that it is not possible to make a reliable statement about actual detections and disturbance detections, which are due to disturbance components, by the radar.

There are appropriate algorithms for ascertaining, detecting, such interference regions, for example Barjenbruch et al: A method for interference cancellation in automotive radar, 2015 IEEE MTT-S International Conference on Microwaves for Intelligent Mobility (ICMIM), 2015 or Fischer et al: Robust detection and mitigation of mutual interference in automotive radar, 2015 16th International Radar Symposium (IRS), 2015, 143-148. These interference regions, in particular the interference locations thereof, that is to say the associated sampling locations in the time signal, are stored in order to keep this information for the further processing. This information can be stored in an interference matrix, for example. The interference regions can be described mathematically as a window function, for example. The window function is chosen for example such that the sampling locations within the disturbed region are set to zero, the sampling locations outside the interference regions retaining the values thereof unchanged.

A step c involves a modified time signal being provided by virtue of the interference region of the time signal being cut. Advantageously, the interference regions are cut by virtue of the interference regions being set to zero. In particular, the sampling locations of the time signal that are affected by the disturbance are zeroed. The sampling locations affected by the disturbance are also referred to as interference locations.

The modified time signal therefore comprises the original time signal with the sampling locations thereof and also the zeroed interference locations.

A step d involves a spectrum of the modified time signal being ascertained and a cut spectrum of the cut interference region being ascertained. The spectrum is ascertained from the modified time signal by means of a Fourier transformation. The cut spectrum is ascertained from knowledge of the interference regions, for example through Fourier transformation of the window function. The cut interference regions mean that a spectrum is obtained that differs from the spectrum of the undisturbed signal. These differences can be rectified by knowing the cut spectrum. Such a cut spectrum corresponds to the characteristic of disturbance components, so-called side lobes, these disturbance components being dependent on the interference regions, that is to say in particular the window function. These disturbance components are distributed around each real frequency that forms a component of the time signal. The amplitude of the disturbance components in the spectrum is dependent on the amplitude of the real frequency around which the disturbance components are distributed. In this case, the disturbance components have a smaller amplitude than the associated frequency, however. In particular, the distribution of the disturbance components in the spectrum is also dependent on the phase, the frequency and the amplitude of the real frequency. Since the disturbance components always have a smaller amplitude than the frequency components around which the side lobes are arranged, actual frequency components can be distinguished from the disturbance components.

Step e involves real frequencies or real frequency components of the spectrum being ascertained. Such a real frequency component is a frequency component that is known with certainty to be an actual frequency component within the available time signal. The real frequency component is therefore not based on disturbance components introduced into the spectrum by the cut interference regions. As already mentioned, the frequency components and the amplitude thereof around which the disturbance components are arranged are always greater than the disturbance components. These real frequencies or frequency components can be ascertained by means of a limit value, for example. It is also possible to ascertain a total maximum and also a local maximum. The ascertained frequency components can be stated with certainty to be real frequency components of the time signal. The real frequency has a characteristic quantity, preferably multiple characteristic quantities, ascertained for it. Characteristic quantities are in particular the amplitude, the phase and/or the frequency of the real frequency component. In particular, step e can involve an individual real frequency or multiple real frequencies being ascertained. The term real frequency component relates here not to a real part or an imaginary part but rather to whether a frequency is actually present in the time signal or is produced as a disturbance frequency by the window function.

A step f involves a modified cut spectrum being ascertained from the cut spectrum from a characteristic quantity of the real frequency component. The characteristic quantities are determined during the ascertainment of the real frequencies or frequency components. Moreover, the cut spectrum is also known on the basis of knowledge of the interference regions, in particular the window function. The cut spectrum can be adapted for the real frequency components on the basis of the characteristic quantity or quantities. In particular, the cut spectrum is shifted to the real frequency and adapted for the amplitude and also the phase of the real frequency, which results in the modified cut spectrum. The modified cut spectrum corresponds to the distribution of the disturbance components around the ascertained real frequency. The adaptation for phase, frequency and amplitude allows the characteristic of the cut spectrum to be ascertained very accurately.

A step g involves the modified cut spectrum being subtracted from the spectrum in order to provide a corrected spectrum. As a result, the disturbance components that were introduced by the real frequencies are removed from the spectrum. Described in other words, the real frequency components and the characteristic quantities thereof are ascertained and these disturbance components are removed from the spectrum by knowing the characteristic of the disturbance components on the basis of the cut spectrum. The corrected spectrum is therefore purged of the disturbance components of the real frequencies. If multiple real frequencies are ascertained according to step e, the disturbance components of all ascertained real frequencies can be removed in step g.

In comparison with the IMAT, which was described briefly in the introduction, just a single Fourier transformation is carried out in step d here. For the IMAT method, three Fourier transformations already are carried out to provide a first corrected spectrum. Moreover, the computation operations of the presented method are much easier to calculate and therefore save on computation capacities.

Particularly advantageously, steps e to g are carried out on the corrected spectrum for a further real frequency component.

As a result, the corrected spectrum is used as starting point for ascertaining further real frequencies or real frequency components. When ascertaining further real frequencies, real frequency components already ascertained according to step e are no longer taken into consideration, since the disturbance components thereof have already been removed according to step g. Further steps f and g are then executed with the newly ascertained real frequencies. Following ascertainment of the characteristic quantities, the modified cut spectrum can be ascertained and the subtraction from the spectrum used as a basis in step e can take place. This provides a further corrected spectrum. The corrected spectrum provided after the first pass corresponds to a first quality level, with the corrected spectrum of the second pass corresponding to a second quality level, etc. In particular, steps e to g can be repeated several times. The removal of disturbance components may result in further real frequency components appearing within the spectrum that were previously overlaid with the disturbance components. The iterative process restores the spectrum of undisturbed time signal step by step.

In comparison with the IMAT method, this allows provision of a high-quality corrected spectrum for comparatively low computation complexity. In particular, the proposed method requires only a single Fourier transformation to be carried out. The IMAT method requires three Fourier transformations to be carried out for a first quality level and another two Fourier transformations for every further quality level. Accordingly, the proposed method provides particularly efficient interference suppression.

The method for signal restoration according to claim 3 comprises at least steps a to e from claim 1 and the explanations above. The method is identical at least for these points.

As an additional step to steps a to e, the ascertained real frequencies are used for signal restoration in order to restore the interference regions. In particular, the frequency, the phase and the amplitude of the real frequency or of the real frequencies can be read from the spectrum. These variables can be used to restore the actual time signal within the interference regions. This allows simple signal restoration.

In addition to steps a to e, steps f to g and the subsequent ascertainment of further real frequency components can also be carried out. This means that the number of ascertained real frequency components is higher, as a result of which improved restoration of the time signal is possible. Steps e to g according to claim 2 can also be carried out several times, in order to increase the number of ascertained real frequencies and thereby to improve the restoration of the time signal within the interference regions.

Accordingly, steps a to g of the method according to claim 1 are carried out for signal restoration, steps e to g being able to be carried out several times. Subsequently, the safe frequencies are then ascertained in order to restore the interference regions of the time signal. To restore the time signal, the applicable frequencies with the amplitude, frequency and phase thereof are summed. This allows the time signal to be restored within the interference regions. In particular, this provides a restored time signal that comprises the original time signal with the restored interference regions.

The signal restoration is much more efficient in this case than according to the IMAT method, since here too just a single Fourier transformation is carried out.

A further method for signal restoration comprises at least steps a to g of claim 1. The corrected spectrum is then used to ascertain the time signal. This can be effected by means of an inverse Fourier transformation, for example. This provides a complete and restored time signal from the corrected spectrum.

There is also the possibility of steps e to g of the method according to claim 1 being carried out several times, as outlined in claim 2. This provides a high-quality spectrum that then provides a restored time signal by means of the inverse Fourier transformation. This method requires just two Fourier transformations for signal restoration. Particularly if a time signal having a high quality level is supposed to be restored, the described method for signal restoration is particularly efficient compared with the IMAT method.

The outlined methods for interference suppression and for signal restoration are all based on the same principle. Advantageous variant configurations of this principle are explained below. These can be applied to all three methods according to claims 1, 2, 3 and 4 mutatis mutandis.

It is proposed that the spectrum be ascertained by means of a Fourier transformation.

Particularly advantageously, the spectrum and the cut spectrum are ascertained for a multiple spatial dimension.

This is advantageous in particular when using time signals of a radar, in particular in the case of FMCW radars, since such systems normally involve multiple Fourier transformations being executed. Each Fourier transformation resolves a further dimension. By way of example, a first step involves the distance, a second step involves the velocity and a third and a fourth step involve the azimuth angle and the elevation angle being resolved. This provides a multidimensional space within which the individual detections by the radar can be ascertained. Various quantities, such as for example phase, amplitude, frequency, etc., are ascertained in the spectrum in order to infer distance, velocity, azimuth angle or elevation angle in relation to the radar therefrom. Moreover, every further resolved dimension results in the signal-to-noise ratio increasing. The resolved dimensions are distance, velocity, elevation angle and/or azimuth angle, inter alia. For the multiple dimension, at least two, three or four dimensions are resolved. By way of example, distance and velocity of the detections.

It should be borne in mind that the IMAT method results in an additional two Fourier transformations arising per quality level for every further dimension. If resolution takes place for 4 dimensions, the IMAT method requires initially 8 Fourier transformations to be carried out to provide a corrected spectrum of the first quality level for 4 dimensions. 4 Fourier transformations in order to ascertain the 4-dimensional spectrum and then 4 inverse Fourier transformations in order to ascertain the corrected time signal. In addition, 4 Fourier transformations are required in order to determine the corrected spectrum from the corrected time signal. In total, this is 12 Fourier transformations and a further 8 for every further quality level. The proposed method requires just 4 Fourier transformations, since the correction is performed directly in the spectrum. Moreover, the Fourier transformations are executed for a standard FMCW radar anyway in order to obtain the spectrum.

Advantageously, the characteristic quantity of the real frequency component is ascertained with high accuracy.

The precise ascertainment of the characteristic quantities, such as frequency, amplitude and/or phase, is particularly advantageous. It also provides the modified cut spectrum precisely. As a result, the disturbance components are removed from the spectrum in targeted fashion. If the characteristic quantities are ascertained inaccurately, then it may be that the disturbance components are not removed correctly and an erroneous corrected spectrum is produced as a result.

Various methods are known for ascertaining the characteristic quantities with high accuracy, in particular zero padding, interpolation (Eric Jacobsen and Peter Kootsookos: Fast, Accurate Frequency Estimators, IEEE Signal Processing Magazine, p. 123-127, May 2007) and lookup tables (DE 10 2012 106 790 A1).

It is proposed that the cutting of the interference region be provided by means of a window function.

Such a window function comprises at least the interference region. These are at least all interference locations. Advantageously, at least all interference locations are set to the value zero. By way of example, the window function is applied to the time signal, as a result of which the interference region is cut. The window function can also relate to regions of the time signal that have no disturbance components, that is to say sampling locations that are not interference locations. By way of example, the window function extends a little beyond the width of the interference regions. This makes it possible to ensure that no marginal regions of the disturbance remain within the modified time signal either.

Alternatively, the window function can also be formed by another function, in particular be performed by a smoothed square-wave function. Such a smoothed square-wave function comprises the square-wave function which does not skip abruptly from 0 to 1 or vice versa, however, but rather falls in smoothed fashion. The region of the transition is referred to as the transition component and can be provided by a cost or sine function, for example. The transition component of the smoothed square-wave function decreases for example the amplitude of the portion of the time signal that is not affected by the disturbance, but is situated at a marginal region of the disturbance. The square-wave component of the smoothed square-wave function preferably covers the entire interference region, the transition component being applied to undisturbed regions or marginal regions of the undisturbed time signal. This decreases the amplitude of some of the sampling locations of the time signal, as a result of which there is provision for the disturbance components of the cut spectrum to have a smaller amplitude in relation to the associated real frequency and also to fall faster as relative frequency rises. As a result, the number of real frequency components that can be ascertained in a first pass is proportionally greater than when a pure square-wave function is used.

Advantageously, the window function is formed by a square-wave function or a smoothed function. Preferably, the smoothed square-wave function also acts on a time signal region adjacent to an interference region.

The methods are in particular used to ascertain targets with high accuracy in a RADAR system even when disturbances in the received signals occur. In particular, this also allows targets to be acquired that were previously unable to be ascertained on account of the disturbances. The method is so efficient that it can be performed in real time even using the low-power hardware of a motor vehicle.

The methods for interference suppression and for signal restoration are explained by way of illustration below with reference to multiple figures, in which:

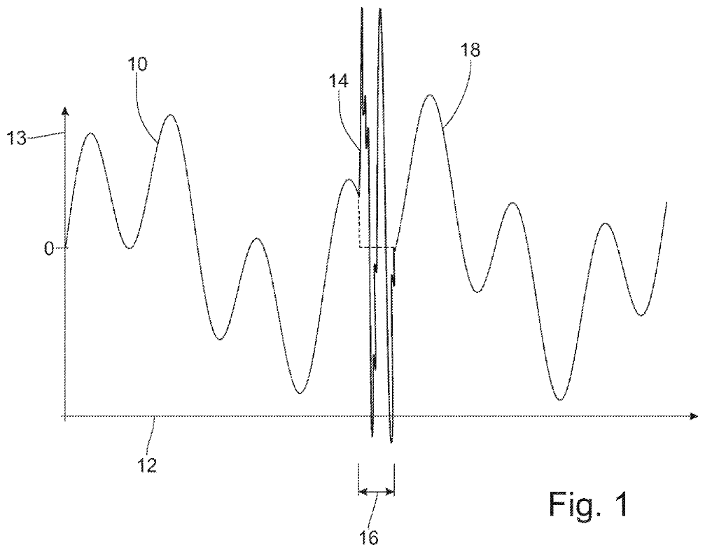

FIG. 1 shows a time signal;

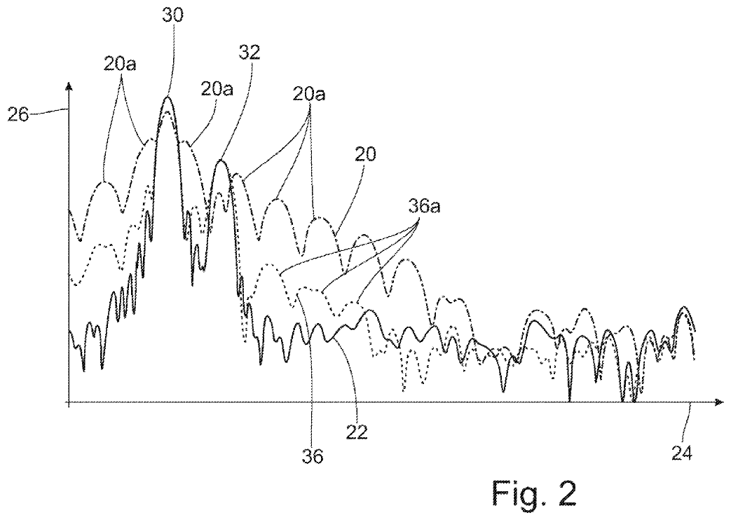

FIG. 2 shows an undisturbed spectrum, a spectrum and a corrected spectrum of the time signal;

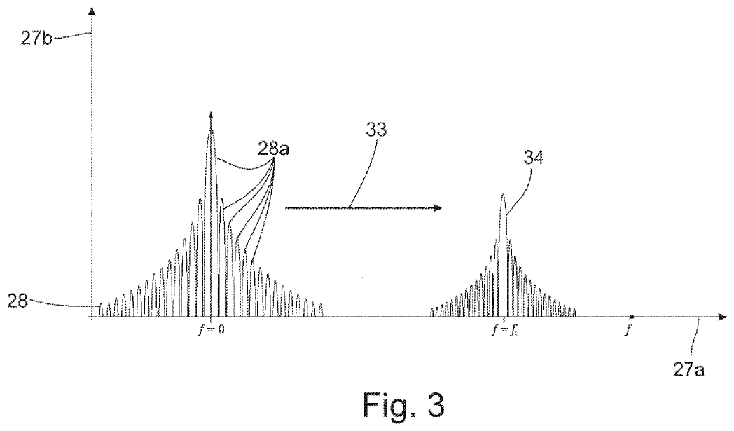

FIG. 3 shows a cut spectrum and a modified cut spectrum;

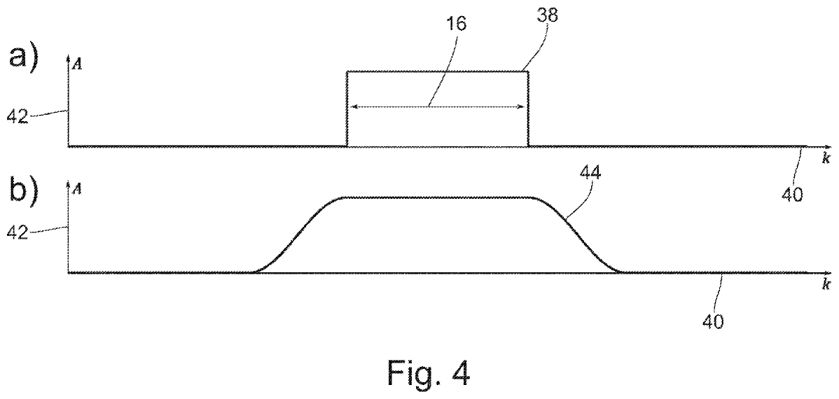

FIG. 4a,b shows various window functions;

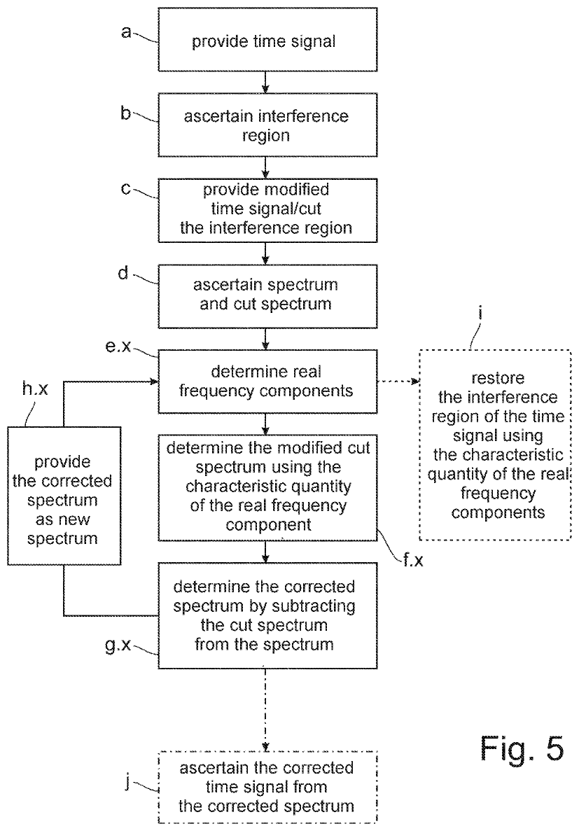

FIG. 5 shows a flowchart for a method for interference suppression and for signal restoration.

The methods for signal restoration and for interference suppression are explained schematically and in a simple manner below. The method(s) is (are) described and performed on the basis of the resolution of a RADAR signal in a single dimension. In principle, the method was developed for application on a RADAR system, in particular an FMCW radar, that resolves in 4 dimensions. To avoid going beyond the framework of the description, however, a resolution in one dimension has been consciously chosen for the explanation. Adapting the method for multiple dimensions, in particular 4, can be accomplished easily if the sequence of the method is known per se.

FIG. 1 depicts a time signal 10 by means of a solid line. The time signal 10 will be provided by a RADAR system. In this case, it is the beat signal of a chirp of an FCMW radar. The transmitted signal reflected by an object and received again has been mixed with the output signal from the transmission antenna and filtered using a low-pass filter. The mixed signal has accordingly been converted into a digital signal that has the sampling locations 0 to 512. The individual sampling locations are plotted along the X axis 12, the amplitude of the digital signal being plotted against the Y axis 13. It can be seen that a signal disturbance 14 is present for the sampling locations 250 to 280. This region is also referred to as interference region 16. Such a signal disturbance 14 can be triggered for example by extraneous radiation received together with the reflected signal.

The individual steps of the method for signal restoration and interference suppression that are explained below are depicted as a flowchart in FIG. 5 and are explained in detail below.

The time signal is provided as first step a.

A further step b involves ascertaining whether the time signal 10 has a signal disturbance 14. This can be done for example using an algorithm that ascertains the interference region 16 of the time signal 10. The interference region 16 comprises the interference locations which comprise those sampling locations of the time signal 10 at which the signal disturbance 14 occurs. The algorithm has ascertained the sampling locations 250 to 280 as interference locations for the time signal 10. The interference region and the interference locations are stored for the remainder of the method. This can be done in the form of an interference matrix, for example.

A step c involves all of the sampling locations of the time signal 10 within the interference region 16 being cut by virtue of said sampling locations being set to the value 0. This provides a modified time signal 18. The modified time signal 18 corresponds to the time signal 10, the dashed line within the interference region 16 depicting the characteristic of the modified time signal. In particular, the amplitude of the time signal within the interference region 16 is set to the value zero for the associated sampling locations, that is to say the interference locations.

Step d involves a spectrum and a cut spectrum being ascertained. The spectrum is obtained from the modified time signal 18. This can be calculated by means of a Fourier transformation, for example. The spectrum 20 obtained from the modified time signal 18 is depicted by the dash-dot line in FIG. 2. Moreover, FIG. 2 depicts the actual spectrum 22 corresponding to the undisturbed time signal by means of a solid line. The actual spectrum 22 therefore corresponds to the comparison case in which no disturbance has occurred. In FIG. 2, the frequency is plotted against the X axis 24 and the amplitude is plotted against the Y axis 26.

The cut spectrum 28 is depicted by way of illustration in FIG. 3. The frequency is depicted against the X axis 27a and the amplitude is depicted against the Y axis 27b.

This cut spectrum is obtained from the window function that was used for cutting the interference region 16 of the time signal 10 in step C. This window function is chosen as square-wave function, which is based on the time signal 10 for the interference locations at zero. The window function is depicted by way of illustration in FIG. 4a). By cutting the interference locations, a disturbance component that behaves in accordance with the cut spectrum 28 is obtained for each real frequency component within the spectrum. In other words, a cut spectrum 28 that depends on the amplitude, the frequency and the phase of the frequency component is distributed around each real frequency component. These so-called disturbance components 28a of the cut spectrum, also called side lobes, are smaller in their intensity or amplitude than the real frequency component.

The modified time signal can be described mathematically for a single chirp of an FMCW radar as follows. A chirp duration of T_{c} is assumed, the interference occurring at the time t₀ and having a duration of Tᵢₙₜ.

$$s ( t ) = {A}_{0} cos ( 2 π {f}_{0} t - {φ}_{0} ) \cdot [ rect ( \frac{t}{{T}_{c}} ) - rect ( \frac{t - {t}_{0}}{{T}_{Int}} ) ] \qquad ( 1 )$$

The first summand describes the frequency components, and the second summand describes the window function. The square-wave functions rect are chosen such that the amplitude within the interference region is set to zero.

The Fourier transform of formula (1), that is to say the spectrum, is obtained as

$$S ( f ) = \frac{{A}_{0}}{2} δ ( f - {f}_{0} ) \cdot {e}^{- j {φ}_{0}} * [ {T}_{c} s i ( π {T}_{c} f ) - {T}_{Int} s i ( π {T}_{Int} f ) \cdot {e}^{- j 2 π f {t}_{0}} ] \qquad ( 2 )$$

In comparison with an undisturbed signal, a second si function arises here, which is convoluted with the target frequency f₀. The si function is weighted with the amplitude A₀ and the phase φ₀. δ(f−f₀) is the Dirac function, which is zero at each location, except for in the case of f−f₀. The disturbance components 28a of the cut function are depicted in FIG. 3.

The cut spectrum is obtained from the Fourier transform of the interference matrix or from the window function used. With the cut spectrum, which is determined using the Fourier transformation, it is known how applicable disturbance components 28a introduced by the window function are arranged around the target frequency and accordingly the real frequency components.

Accordingly, the spectrum and the cut spectrum are now known. It is also known that the disturbance components 28a have a smaller amplitude than the associated real frequency components.

A further step e involves the real frequency components of the spectrum being ascertained. This can be done using a limit value analysis, for example. This involves the highest value of the spectrum being determined and a limit value being stipulated. All frequency components that are above this limit value can be regarded as real frequency components. Alternatively, there is also the possibility of the search for absolute maxima or for local maxima, the local maxima needing to represent a maximum over a sufficient spectral frequency width.

These frequency components are now known with certainty to be real frequency components of the modified time signal 18, and not disturbance components. The characteristic quantities amplitude, phase and frequency are now determined for these real frequency components.

The spectrum 22 for FIG. 2 is depicted, which detects two targets for a RADAR measurement by an FMCW RADAR. The spectrum 22 comprises a first target 30, which has the largest amplitude at a frequency value of 50, and a second target 32, which is at a frequency value of approximately 75. The real frequency components can be detected on the basis of the characteristic of the curve 22.

This spectrum is the resolution of the chirp with respect to the dimension of distance. A target can be ascertained by an amplitude maximum in this case, the associated frequency value being able to be converted into the actual distance of the detection. The distance is proportional to the measured frequency value in this case. This means that a higher frequency value corresponds to a greater distance. The frequency values 50 and 75 correspond to the real frequency components of the time signal 10.

In FIG. 2, it can be seen that the spectrum 20 obtained from the modified time signal 18 has disturbance components 20a in comparison with the actual spectrum 22. These disturbance components 20a are in a distributed arrangement around the real frequency component 30 and have a smaller amplitude than the latter. The amplitude of the disturbance components 20a is greater than the amplitude of the real second frequency component 32.

The amplitude, frequency and phase of the real first frequency component 30 are now ascertained. This can be carried out by means of the methods already mentioned in the general description, for example, which provide precise ascertainment. After the real frequency has been ascertained using one of these methods, the amplitude and the phase can be determined as follows in the interpolation method, for example using a single-point DFT:

$$S ( {f}_{0} ) = {\sum }_{k} x [ k ] \cdot {e}^{- j 2 π {f}_{0} {T}_{S} k} \qquad ( 3 )$$

The variables in this instance are the sampling interval Tₛ, the discrete signal x[k] with the k sampling locations. The signal x[k] and the sampling locations can be multidimensional in this case. As a result, the frequency value S(f₀) is obtained as a complex value with the amplitude |S(f₀)| and the phase φ₀. |S(f₀)| corresponds in this case to the amplitude of the real frequency component. The amplitude A₀ of the cut spectrum can be derived from the first component of formula 2 as

$$\vert S ( {f}_{0} ) \vert = \frac{{A}_{0}}{2} \cdot ( {T}_{c} - {T}_{Int} ) \qquad ( 4 )$$

where f−f₀=0. Following rearrangement of equation (4), the amplitude A₀ of the cut spectrum is obtained as

$${A}_{0} = \frac{2 \vert S ( {f}_{0} ) \vert}{{T}_{c} - {T}_{Int}} \qquad ( 5 )$$

An alternative possibility, as already mentioned, is also the zero padding method or lookup tables.

The characteristic quantities, which are now known, are used in a further step f to ascertain the modified cut spectrum. The cut spectrum 28 is already known. The characteristic quantities are now used to correct the amplitude of the cut spectrum, to adapt the phase thereof and to shift said phase to the target frequency f₀, that is to say the first real frequency 30 here. This is depicted graphically in FIG. 3, the transformation being illustrated by the arrow 33. This results in the modified cut spectrum 34. The modified cut spectrum 34 corresponds to the disturbance components introduced into the spectrum by the window function.

The modified cut spectrum 34 is now cut from the spectrum 20 in a step g. In particular, the spectrum 20 has the modified cut spectrum 34 subtracted from it, which results in a corrected spectrum 36. The corrected spectrum 36 is depicted as a dashed line in FIG. 2. Since the disturbance components have now been removed, the second real frequency component 32 emerges from the spectrum. In comparison with the spectrum 20, the second real frequency component can be identified. Moreover, the disturbance components 36a of the second real frequency 32 can now be seen in FIG. 2.

The comparison of the spectrum 20 with the corrected spectrum 36 clearly shows that the disturbance components are actively suppressed. The second frequency component 32 can be uniquely identified as a result. This was not the case with the disturbed time signal 10. Moreover, the computation complexity is low in comparison with the already known methods on account of the small number of Fourier transformations and the simple mathematical operations.

In order to perform a further optimization of the corrected spectrum 36, a step h can involve the corrected spectrum 36 being used as a basis for a further correction. The corrected spectrum 36 is accordingly used as a basis for step e.

Step e.2 then involves further real frequency components being determined. The already known real frequency components are no longer taken into consideration, since the spectrum has already been purged of the disturbance components of said frequency components. The newly ascertained real frequency components are evaluated in order to ascertain the characteristic quantities thereof, so as then to ascertain one or more modified cut spectra in a step f.2. These modified cut spectra are then subtracted from the corrected spectrum on which step e was based in step g.2. in order to provide a corrected spectrum of the second level.

These steps can be repeated several times in order to provide an iterative improvement in the spectrum and to eliminate the applicable disturbance components. In FIG. 5, the steps are labelled e.x, f.x, g.x and h.x, x representing the number of the respective iterative step.

For a step e, it may be that just a single real frequency component is ascertained or multiple real frequency components are ascertained. In the latter case, disturbance components of different real frequency components can be cut in a single pass.

The preceding description of the method relates by way of illustration to a RADAR system, in particular an FMCW radar, that is resolved only in one dimension, distance. In principle, the method can also be applied in a higher dimensional space that resolves for distance, velocity, elevation angle and/or azimuth angle, inter alia. Accordingly, multiple time signals and multidimensional spectra, multidimensional corrected spectra, multidimensional cut spectra and multidimensional modified cut spectra are present.

The number of iteration processes can be dependent on various factors. By way of example, the number of iteration steps is predefined, the number of targets to be ascertained or a specific limit value.

By way of example, a limit value can be used for ascertaining the real frequency components, all frequency components above the limit value being regarded as real frequency components. The limit value is set to 5, 10 or 15% below a maximum amplitude of the spectrum, for example. In principle, the limit value can also be estimated using formula (5), which stipulates the maximum amplitude of the disturbance components in relation to the amplitude of the frequency components. The limit value is lowered for each iteration step as appropriate. All frequency components situated above the limit value are accordingly regarded as real frequency components of the time signal.

In principle, it is not necessary to apply correction of the signal and of the spectrum to all real frequency components. In particular, real frequency components with a small amplitude no longer need to be corrected in the spectrum.

In principle, the evaluation of measurement data or measurement signals from an FMCW RADAR usually involves the dimensions being determined in succession by means of Fourier transformations. Usually, the dimension of the distance is determined first, then the velocity dimension and finally the angle dimensions, by means of Fourier transformations. The method can be applied between each of the steps in this case. By way of example, the method can be applied after resolution of the distance dimension, and the corrected spectra are used to resolve the further dimensions. The method can also be carried out after the provision of 2, 3 or after provision of the 4th dimension, however.

Instead of a square-wave signal, which was used to provide the modified time signal 18 for FIG. 1 by way of illustration, another window function can also be selected. The window function 38 according to FIG. 4a is the square-wave function. The time, or the sampling locations, is plotted against the X axis 40, and a factor that, by way of illustration, is between 1 and 0 is plotted against the Y axis 42. The factor determines the value by which the amplitude or the respective sampling location is decreased. The square-wave function corresponds to the width of the interference region 16 along the X axis 40 and therefore comprises the interference locations.

Instead of the square-wave function 38, a smoothed square-wave function 44, as depicted in FIG. 4b, can also be used. This comprises the square-wave function 38 over the width of the interference region 16, a fall from 1 to 0 not taking place at the ends, but rather a uniform transition from 1 to 0 being effected. The transition can be performed in different ways. The cost function has been chosen mathematically in this case. The transition from 1 to 0 can extend over a width of between 5 and 30 sampling locations. This certainly firstly decreases sampling locations for the amplitude of the time signal 10, although no disturbance components 14 arise in this region. Secondly, it advantageously adapts the characteristic of the cut spectrum and the disturbance components thereof. The choice of a suitable window function allows a smaller amplitude to be achieved for the disturbance components in comparison with the square-wave function, see formulae (2) and (5), and also a faster fall to be achieved for rising relative frequency at the target frequency or the real frequency component. The method becomes more robust as a result.

The method steps explained above in order to provide a suppressed-interference spectrum can also be used to restore or reconstruct a time signal. In a first variant, for example steps a to e according to FIG. 5 and the above parts of the description can be performed. Step i is then performed. This involves the ascertained characteristic quantities of the real frequency components, such as frequency, phase and amplitude, being used in order to restore the cut interference regions. This is accomplished by explicitly using the amplitude, frequency and phase and adding them in the form of sine functions.

In this case, the characteristic quantities of the real frequency components can be used after a first pass of step e.1, or steps e to h are carried out several times in order to determine further real frequency components. After multiple iteration steps have been carried out, the time signal can be reconstructed again with high quality.

In another variant for reconstructing the time signal, at least steps a to g according to FIG. 5 and the associated above embodiments are performed and the time signal is then determined from the corrected spectrum in a step j. The corrected spectrum can be converted into the time signal by means of an inverse Fourier transformation, for example, the disturbance components already having been cut.

It is possible for the corrected spectrum to be provided after a first pass of steps a to g, or for steps e to g and h to be executed several times as appropriate. Step h is executed one time fewer than each of steps e to g. This achieves a further improvement in the spectrum. Moreover, carrying out a small number of Fourier transformations and inverse Fourier transformations allows efficient reconstruction of a time signal.

### REFERENCE SIGNS

10 time signal
12 x axis (sampling locations)
13 y axis (amplitude)
14 signal disturbance
16 interference region
18 modified time signal
20 spectrum
20a disturbance component
22 actual spectrum
24 x axis (frequency)
26 y axis (amplitude)
27a x axis (frequency)
27b y axis (amplitude)
28 cut spectrum
28a disturbance component/side lobe
30 first target/first frequency component
32 second target/second frequency component
33 arrow
34 modified cut spectrum
36 corrected spectrum
36a disturbance component
38 square-wave function (window function)
40 x axis (time/sampling locations)
42 y axis (factor)
44 smoothed square-wave function (window function)
a step
b step
c step
d step
e.x step
f.x step
g.x step
h.x step
i step
j step

1. A method for interference suppression comprising,
a. providing a time signal (10),
b. ascertaining an interference region (16) of the time signal (10),
c. providing a modified time signal (18) by virtue of the interference region (16) of the time signal (18) being cut,
d. ascertaining a spectrum (20) of the modified time signal (18) and ascertaining a cut spectrum (28) of the cut interference region (16) is ascertained,
e. ascertaining a real frequency component (30) of the spectrum (20),
f. ascertaining a modified cut spectrum (34) from the cut spectrum (28) from a characteristic quantity of the real frequency component (30),
g. subtracting the modified cut spectrum (34) from the spectrum (20) in order to provide a corrected spectrum (36).

2. The method as claimed in claim 1, wherein steps e to g are carried out on the corrected spectrum (36) for a further real frequency component (32).

3. A method for signal restoration, wherein at least steps a to e of claim 1 are carried out, the ascertained real frequency component (30) being used to restore the interference region (16) of the time signal (10).

4. A method for signal restoration, wherein at least steps a to g of claim 1 are carried out, a restored time signal being ascertained from the corrected spectrum (36).

5. The method as claimed in claim 1, wherein the spectrum (20) is ascertained by means of a Fourier transformation.

6. The method as claimed in claim 1, wherein the spectrum (20) and the cut spectrum (28) are ascertained for a multiple spatial dimension.

7. The method as claimed in claim 1, wherein the characteristic quantity of the real frequency component (30, 32) is ascertained with high accuracy.

8. The method as claimed in claim 1, wherein the cutting of the interference region (16) is provided by means of a window function (38, 44).

9. The method as claimed in claim 8, wherein the window function (38, 44) is formed by a square-wave function (38) or a smoothed square-wave function (44) that also relates to time signal regions adjacent to the interference regions.
